(19) United States
(12) Patent Application Publication
(10) Pub. No.: US 2017/0348695 A1
(43) Pub. Date: Dec. 7, 2017

(54) SECONDARY SHREDDER

(71) Applicant: Eco Green Equipment, LLC, North Salt Lake, UT (US)

(72) Inventors: Ted Bushman Rogers, Salt Lake City, UT (US); Jarom Wayne Groat, Salt Lake City, UT (US)

(21) Appl. No.: 15/175,999

(22) Filed: Jun. 7, 2016

(51) Int. Cl. B02C 18/14; B02C 23/10; B29B 17/04; B29B 17/02; B02C 18/18; B29K 105/08; B29K 21/00

(52) U.S. Cl. CPC B02C 18/145; B29B 17/0206; B02C 23/10; B02C 18/18; B29B 17/0412; B02C 2018/188; B02C 2201/04; B29B 2017/0424; B29K 2021/00; B29K 2105/08

(57) ABSTRACT

A secondary shredder can include a rotor assembly that employs a modular rotor design. Each rotor of the rotor assembly can include a number of blades that are symmetrical around a horizontal and a vertical axis. Each rotor can include a number of radial extensions forming gaps into which the blades insert. The blades can be secured within the gaps by wedges that apply an inward force against the blades when the wedges are secured into the gaps. The radial extensions and blades can include keyways into which keys insert to prevent the blades from escaping the gaps. The secondary shredder may also include a stationary knife assembly that includes multiple stationary knives that are positioned on the same side of the rotor assembly.

### CROSS-REFERENCE TO RELATED APPLICATIONS

Not Applicable.

### BACKGROUND

Tire shredder systems are employed to convert whole tires into shredded particles that can be employed for a number of different purposes. Many tire shredder systems employ a two-stage shredding process. First, whole tires are fed through a primary shredder which converts the tires into larger-sized shreds (e.g., a rough shred down to a 2 inch shred). Next, these larger-sized shreds can be fed through a secondary shredder which will convert them into small-sized particles (e.g., into approximately 0.25 to 2 inch particles). Also, in many systems, the secondary shredder is employed to remove the metal wire from the rubber particles. Therefore, the typical output of the secondary shredder is a wire-free rubber mulch.

Many secondary shredders employ a rotor design in which a single rotating head (or rotor) to which blades are mounted is rotated as the larger-sized shreds are fed into the secondary shredder. These rotor-based designs also typically include a number of stationary knives that are positioned in close proximity to the rotating blades thereby forming a shredding interface as the rotor rotates. At the shredding interface, the larger-sized shreds will be forced between the rotating blades and the stationary knives resulting in the shreds being cut/ripped into the small-sized particles. These secondary shredders will also typically have a screen through which appropriately sized particles of rubber and wire can fall to exit the shredding area and which will cause particles that have not yet been reduced to the appropriate size to be recirculated through the shredding interface. After falling through the screen, the particles can be passed by a magnet that will remove the wire particles from the rubber particles thereby producing the rubber mulch.

### BRIEF SUMMARY

The present invention extends to a secondary shredder and components of a secondary shredder. A secondary shredder can include a rotor assembly that employs a modular rotor design. Each rotor of the rotor assembly can include a number of blades that are symmetrical around a horizontal and a vertical axis. Each rotor can include a number of radial extensions forming gaps between adjacent radial extensions into which the blades insert. Each blade can be secured within a gap by a wedge that presses the blade against the radial extension. The radial extensions and blades can include keyways into which keys insert to prevent the blades from escaping the gaps and which provide consistent orientation of the blade within the gap. The secondary shredder may also include a stationary knife assembly that includes multiple stationary knives that are positioned on the same side of the rotor assembly.

In one embodiment, the present invention is configured as a secondary shredder that includes a body having an internal compartment and an opening into the internal compartment, a stationary knife assembly comprising one or more stationary knives positioned within the internal compartment, and a rotor assembly positioned within the internal compartment. The rotor assembly has one or more rotors that each has a plurality of blades which form a shredding interface with each of the one or more stationary knives. Each blade is symmetrical around a horizontal axis and a vertical axis.

In another embodiment, the present invention is configured as a secondary shredder that includes a body having an internal compartment and an opening into the internal compartment, a stationary knife assembly comprising a first set of stationary knives and a second set of stationary knives that extend along a width of the internal compartment and protrude into the internal compartment, and a rotor assembly comprising a plurality of rotors. Each rotor comprises a number of radial extensions that are spaced around a circumference of the rotor thereby forming a number of gaps. Each gap includes a blade and a wedge that secures the blade to an adjacent radial extension. The rotor assembly is positioned within the internal compartment such that the blades form a shredding interface with the first and second sets of stationary knives.

In another embodiment, the present invention is implemented as a rotor for use in a secondary shredder. The rotor includes a circular shaped body having a number of radial extensions spaced around a circumference of the body thereby forming a number of gaps. For each gap, the rotor includes a blade and a wedge that insert into the gap. The wedge secures the blade to the corresponding radial extension. Each radial extension and each blade includes opposing keyways into which keys insert to prevent the blade from escaping the gap.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a top perspective view of a secondary shredder that is configured in accordance with embodiments of the present invention;

FIG. 1A illustrates a detailed view as identified in FIG. 1;

FIG. 2 illustrates a front view of the secondary shredder of depicted in FIG. 1;

FIG. 2A illustrates a cross-sectional view as identified in FIG. 2;

FIG. 3 illustrates a single rotor of a rotor assembly that can be employed within a secondary shredder configured in accordance with embodiments of the present invention;

FIG. 3A illustrates a detailed view as identified in FIG. 3;

FIG. 4A represents a front or rear perspective view of a blade that can be employed on a rotor of the rotor assembly;

FIG. 4B represents a front or rear view of the blade;

FIG. 4C represents a left side or right side view of the blade;

FIG. 4D illustrates how the configuration of a blade allows the blade to be coupled to a rotor in four different orientations;

FIG. 4E illustrates how the leading edges of a blade can be ground down without altering how the blade is secured to the rotor; and

FIG. 5 illustrates an exploded perspective view of a rotor assembly that can be employed within a secondary shredder configured in accordance with embodiments of the present invention.

### DETAILED DESCRIPTION

A secondary shredder as described herein may typically be used to shred rubber tires. However, a secondary shredder configured in accordance with embodiments of the present invention could be employed to shred other types of materials. Also, the term secondary should not be viewed as limiting the shredder of the present invention to use within a shredding system that employs a primary shredder. Instead, the term secondary refers to the fact that the shredder is employed to shred material of relatively smaller size. Accordingly, the present invention should not be limited to use in any particular system or for use in shredding any particle type of material. The present invention extends to a secondary shredder and components of a secondary shredder. A secondary shredder can include a rotor assembly that employs a modular rotor design. Each rotor of the rotor assembly can include a number of blades that are symmetrical around a horizontal and a vertical axis. Each rotor can include a number of radial extensions forming gaps between adjacent radial extensions into which the blades insert. Each blade can be secured within a gap by a wedge that presses the blade against the radial extension. The radial extensions and blades can include keyways into which keys insert to prevent the blades from escaping the gaps and which provide consistent orientation of the blade within the gap. The secondary shredder may also include a stationary knife assembly that includes multiple stationary knives that are positioned on the same side of the rotor assembly.

In one embodiment, the present invention is configured as a secondary shredder that includes a body having an internal compartment and an opening into the internal compartment, a stationary knife assembly comprising one or more stationary knives positioned within the internal compartment, and a rotor assembly positioned within the internal compartment. The rotor assembly has one or more rotors that each has a plurality of blades which form a shredding interface with each of the one or more stationary knives. Each blade is symmetrical around a horizontal axis and a vertical axis.

In another embodiment, the present invention is configured as a secondary shredder that includes a body having an internal compartment and an opening into the internal compartment, a stationary knife assembly comprising a first set of stationary knives and a second set of stationary knives that extend along a width of the internal compartment and protrude into the internal compartment, and a rotor assembly comprising a plurality of rotors. Each rotor comprises a number of radial extensions that are spaced around a circumference of the rotor thereby forming a number of gaps. Each gap includes a blade and a wedge that secures the blade to an adjacent radial extension. The rotor assembly is positioned within the internal compartment such that the blades form a shredding interface with the first and second sets of stationary knives.

In another embodiment, the present invention is implemented as a rotor for use in a secondary shredder. The rotor includes a circular shaped body having a number of radial extensions spaced around a circumference of the body thereby forming a number of gaps. For each gap, the rotor includes a blade and a wedge that insert into the gap. The wedge secures the blade to the corresponding radial extension. Each radial extension and each blade includes opposing keyways into which keys insert to prevent the blade from escaping the gap.

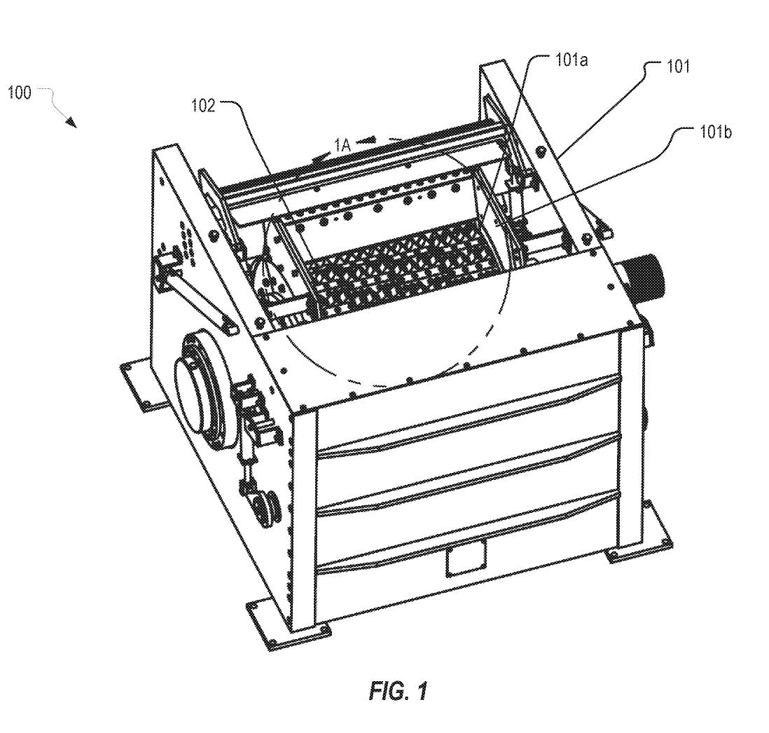

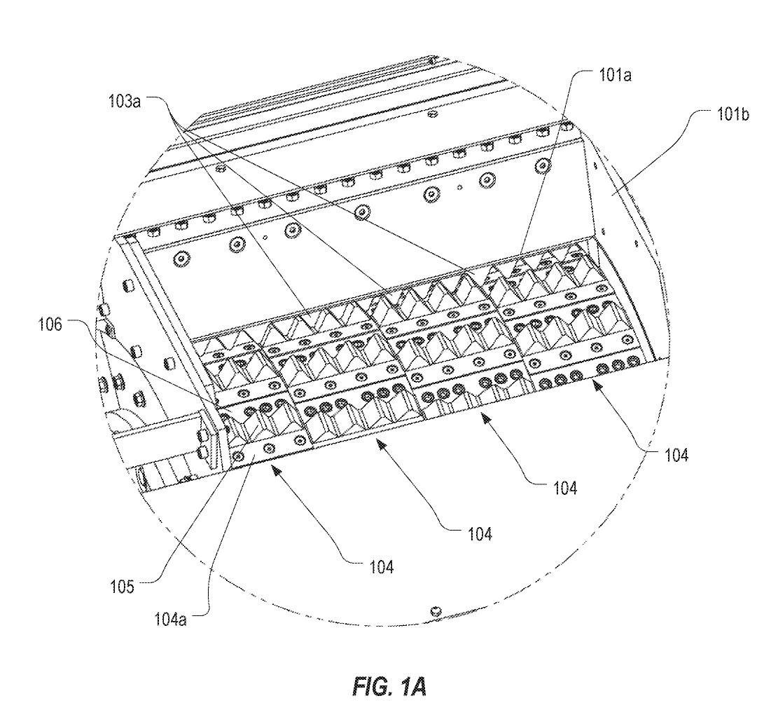

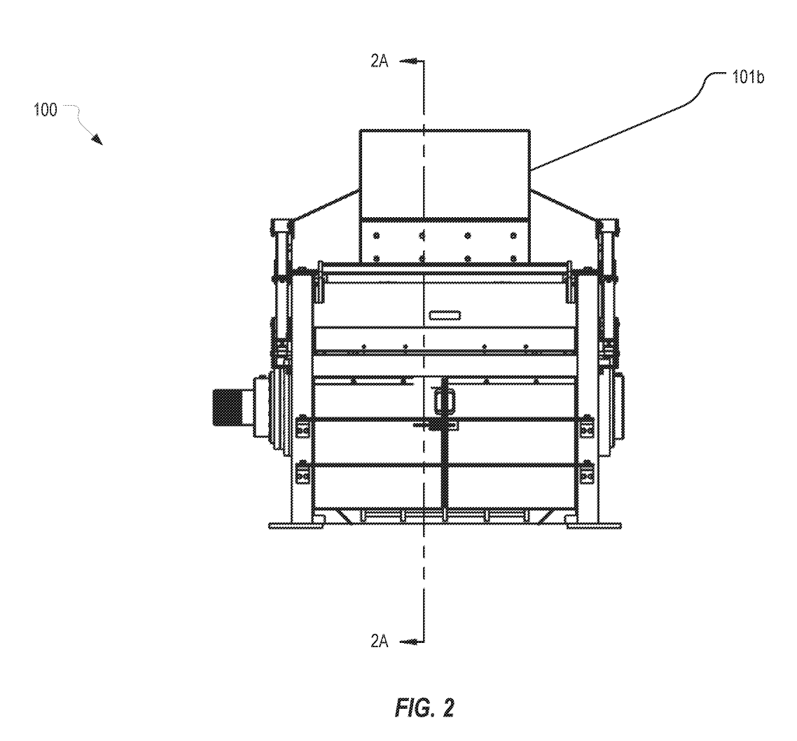

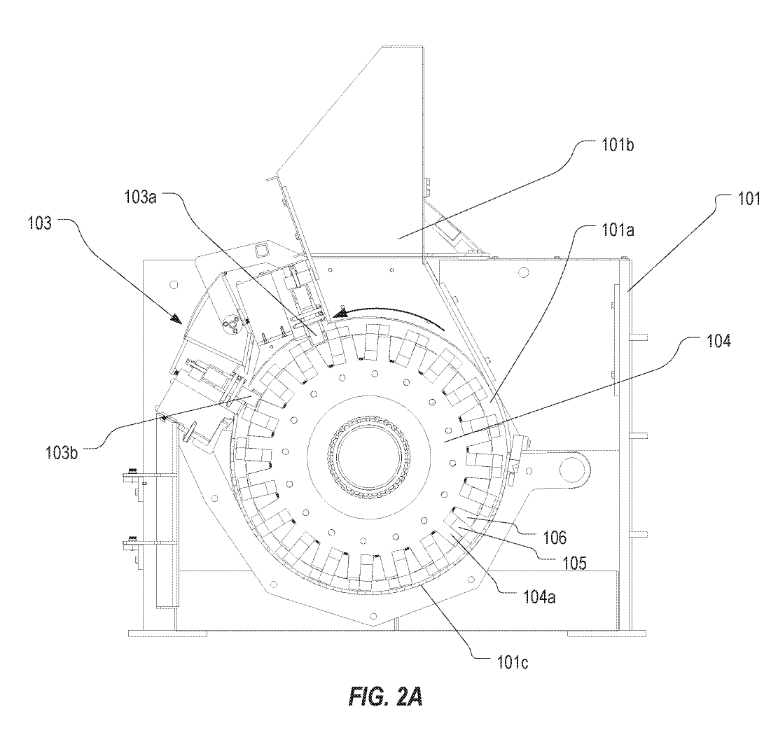

FIGS. 1-2A each illustrate a view of a secondary shredder 100 that is configured in accordance with one or more embodiments of the present invention. Secondary shredder 100 generally comprises a body 101 having an internal compartment 101a in which a rotor assembly 102 is housed. An opening 101b is formed through body 101 and into compartment 101a. Material to be shredded can be input into internal compartment 101a via opening 101b. The diameter of internal compartment 101a can be slightly larger than the outer diameter of rotor assembly 102 thereby allowing rotor assembly 102 to be rotated within internal compartment 101a.

With reference to FIG. 1A, rotor assembly 102 can include a number of rotors 104 which are secured together along an axis of rotation. In the depicted example, rotor assembly 102 includes four rotors 104. However, a rotor assembly could equally include greater or fewer rotors 104 in some embodiments. In fact, as will be further described below, rotor assembly 102 can employ a modular design to facilitate the addition or removal of a rotor 104 from the assembly.

As is best shown in FIG. 2A, each rotor 104 has a generally circular or cylindrical shape and includes a number of radial extensions 104a that are equally spaced around the circumference of the rotor. These radial extensions 104a form a number of gaps between adjacent radial extensions that are spaced around the circumference of the rotor. The role of each of these gaps is to receive and secure a blade 105. As will be further described below, these blades 105 can be secured to rotor 104 by employing a wedge 106.

Secondary shredder 100 can also include a stationary knife assembly 103 which includes two (or possibly more) sets of stationary knives 103a and 103b that span the width of rotor assembly 102 (or more particularly, the combined width of rotors 104). Stationary knives 103a and 103b can extend inwardly into internal compartment 101a and can have a cutting profile that corresponds to the cutting profile of blades 105. For example, as best shown in FIG. 1A, stationary knives 103a and 103b can be structured with a triangular pattern that corresponds to the triangular pattern of blades 105 thereby allowing the tips of blades 105 to insert between the tips of stationary knives 103a and 103b to form a shredding interface. In other words, the close proximity of stationary knives 103a and 103b to blades 105 will form a shredding interface when rotor assembly 102 is rotated.

In FIG. 2A, the direction of rotation during normal operation is represented by the arrow. Accordingly, materials input through opening 101b will first be forced through the shredding interface formed between blades 105 and stationary knives 103a and then through the shredding interface formed between blades 105 and stationary knives 103b. As shown, stationary knives 103a can be positioned near or at opening 101b (i.e., towards the top of rotors 104) so that the materials quickly come into contact with the stationary knives. One benefit of positioning stationary knives 103a near the top of rotors 104 is that it causes stationary knives 103a to be oriented nearly vertically which will prevent the materials from building up against the stationary knives. In other words, due to the near-vertical orientation of stationary knives 103a, gravity will prevent the materials from building up against the leading face of stationary knives 103a.

Stationary knives 103b can also be positioned on the same side of rotor assembly 102 as stationary knives 103a. For example, as shown in FIG. 2A, stationary knives 103b can be positioned within the same quadrant as stationary knives 103a. This will cause the materials to be shredded twice before reaching a screen 101c that is positioned at the bottom of body 101. Because the materials will be subjected to two sets of stationary knives before reaching screen 101c, it is much more likely that the materials will have been reduced to the appropriate size upon reaching the screen and will therefore exit body 101. This can minimize the amount of materials that will be recirculated around internal compartment 101a which in turn will increase the efficiency of the shredding process.

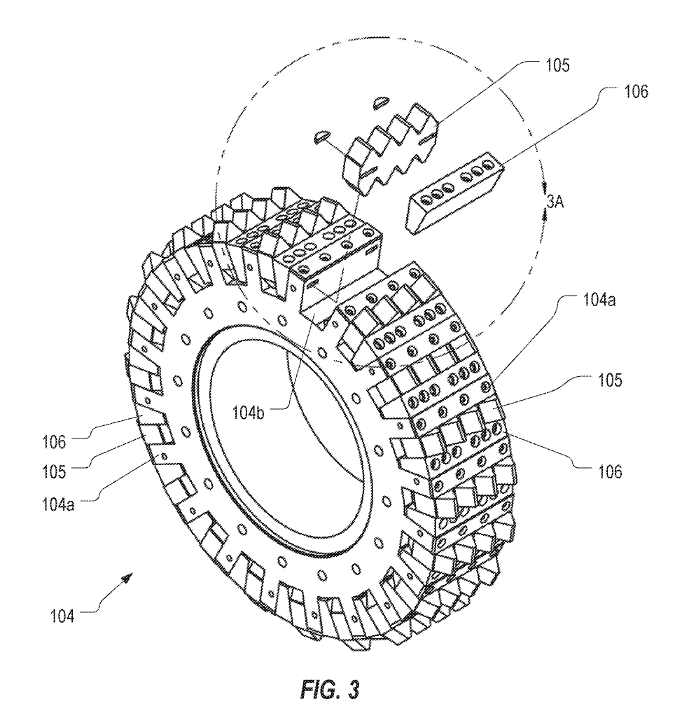

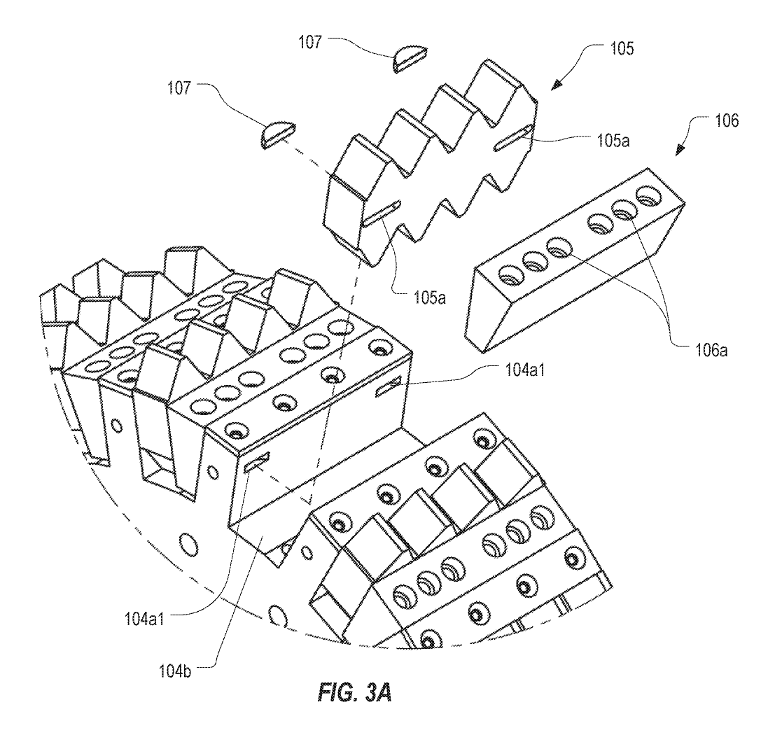

Turning to FIGS. 3 and 3A, a rotor 104 is shown in isolation. Each rotor 104 can be ring-shaped (i.e., each rotor 104 can have an opening passing through its middle) which can allow a cooling fluid or air to be circulated through rotor assembly 102 during the shredding process. As mentioned above, rotor 104 can include a number of radial extensions 104a that form gaps 104b along the circumference of the rotor. The width of gaps 104b can generally correspond to the combined width of blade 105 and wedge 106 thereby allowing a blade 105 and a wedge 106 to be inserted into each gap 104b.

To secure and position blade 105 within gap 104b, each radial extension 104a can include keyways 104a1 into which keys 107 can insert. Each blade 105 can also include corresponding keyways 105a that are centered on each side of the blade. Accordingly, blade 105 can be positioned against radial extension 104a with keys 107 inserting into both keyways 104a1 and 105a. Then, to lock blade 105 in this position, wedge 106 can be inserted into gap 104b alongside blade 105 and bolted down via holes 106a. The wedge shape of wedge 106 will cause a sandwiching or pressing force to be applied to blade 105. This sandwiching force combined with keys 107 will retain blade 105 in place.

The wedge shape also increases the tolerances of gap 104b and blade 105. In other words, because wedge 106 will apply a greater sandwiching force as it is tightened further into gap 104b, there is no need for the width of blade 105 to be precise. If one blade 105 happens to have a slightly smaller width, or equally if the width of one gap 104b happens to be slightly larger, wedge 106 can simply be tightened further into gap 104b to apply the necessary sandwiching force to hold the blade in place.

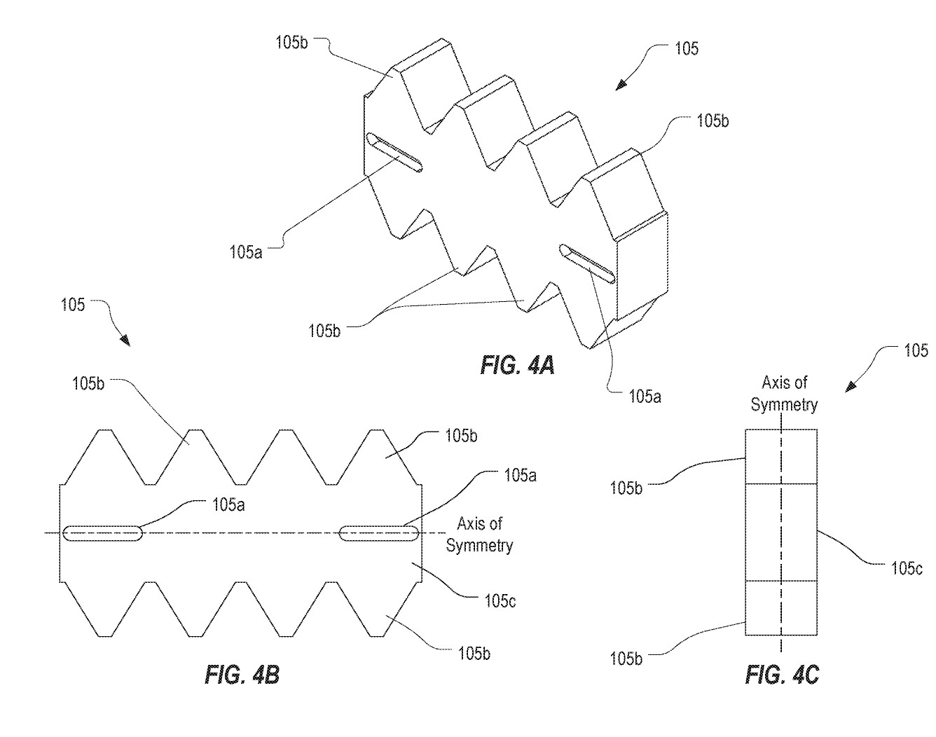

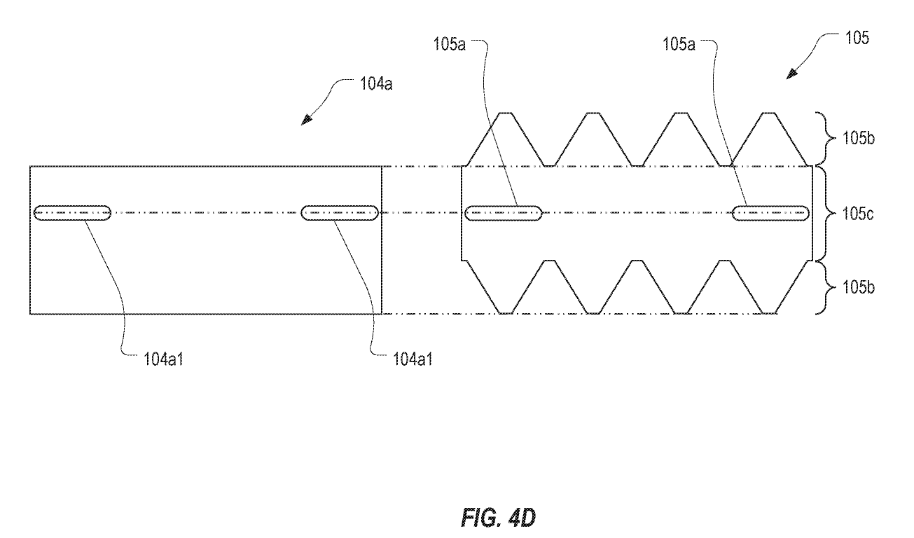

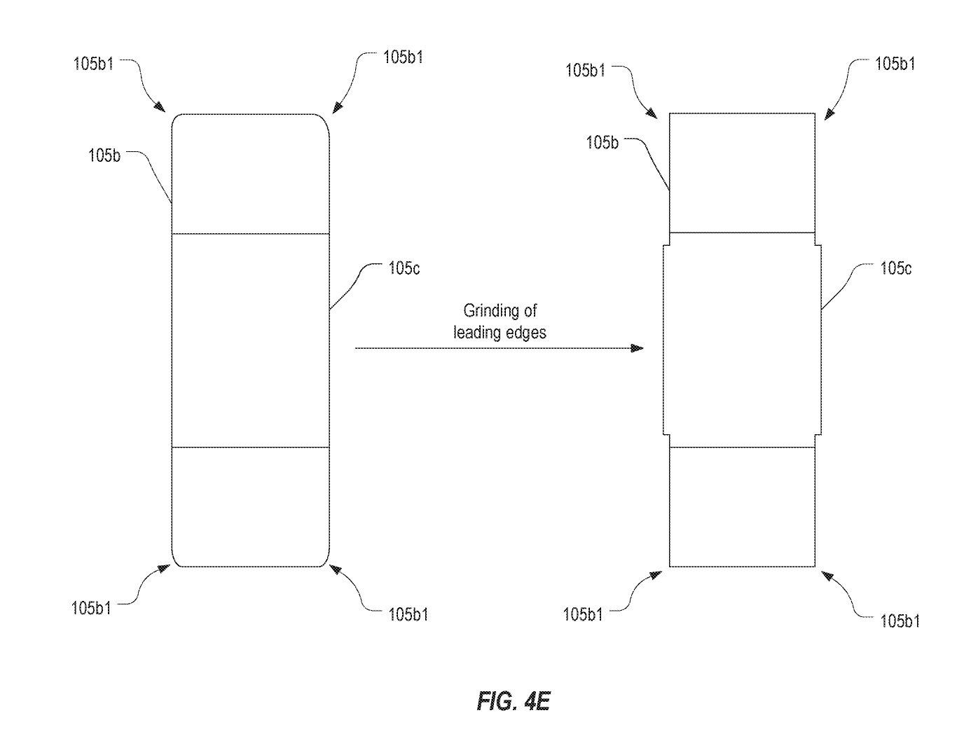

FIGS. 4A-4C illustrate blade 105 in isolation. Blades 105 can be symmetrical about a horizontal axis and a vertical axis as represented by the dotted lines in FIGS. 4B and 4C respectively. This symmetry allows blades to be positioned within gap 104b in any of four different orientations. Because the leading edge of blade 105 (e.g., the leftward-facing edge in FIG. 2A) performs the shredding function, this leading edge will become worn over time. For example, this leading edge, which would form a vertical edge when new, can begin to taper backwards (especially at the tip) due to the wear and tear of shredding the materials. However, due to the symmetrical design of blade 105, any one of the four edges can serve as the leading edge. Because keyways 105a are positioned on the horizontal axis of symmetry and are formed on both sides of blade 105, these keyways will align with keyways 104a1 regardless of which of the four possible orientations blade 105 is placed in.

Also, because blade 105 is symmetrical about the vertical axis, the tips of blade 105 will always be appropriately positioned with respect to stationary knives 103a and 103b. FIG. 4D illustrates this. As shown, each blade 105 can include a body portion 105c and tip portions 105b that extend from a top and bottom side of body portion 105c. The combined height of body portion 105c and one of tip portions 105b can be approximately equal to the height of radial extension 104a as represented by the dashed lines. As a result, the outer edge of body portion 105c will substantially align with the outer edge of radial extension 104a while the exposed tip portion 105b will extend beyond the outer edge of radial extension 104a. Due to the symmetry, this will be the case regardless of the orientation of blade 105.

A primary benefit of having symmetrical blades 105 is that it allows the blades to be repositioned into one of the other three orientations when the leading edge in the current orientation becomes worn. This repositioning can be performed in a relatively quick and easy manner due to the fact that blades 105 are properly positioned using keyways and keys and easily secured in place by wedge 106. In particular, by removing wedge 106, a blade 105 can also be removed from gap 104b, reoriented to use a different leading edge, and re-secured with the wedge. Because wedge 106 is coupled to rotor 104 using bolts that are accessible from the outer/exposed surface of the wedge, a blade 105 could be reoriented even without removing rotor assembly 102 from body 101 (e.g., by accessing wedge 106 and blade 105 via opening 101b.

By using wedge 106, there is no need to directly bolt blade 105 to rotor 104 thereby facilitating the repositioning of blade 105. In particular, if blade 105 was configured to be bolted to rotor 104, the location of the bolt holes would minimize the number of orientations that blade 105 could be positioned in. By using keyways 105a and a wedge 106, a symmetrically designed blade can be employed.

The use of wedge 106 and keys 107 to secure blade 105 also allows a worn edge to be reground without affecting how blade 105 couples to rotor 104 and interfaces with stationary knives 103a and 103b. This is represented in FIG. 4E. As shown on the left side of the figure, a blade 105 includes leading edges 105b1 that have become worn. These leading edges 105b1 can be ground flat to remove the worn (or rounded edge) as is represented on the right side of the figure. This grinding can be performed only on the tip portion 105b of blade 105 so that keyways 105a are not affected. As a result, blade 105 can again be secured in any of the four orientations using wedge 106. This ability to grind the edges of blade 105 can greatly increase the useful lifespan of the blade. For example, in some instances, each leading edge can be ground up to 2 mm at a time for a total of 6 mm (i.e., each leading edge may be ground at least three times). With four available leading edges, this would allow a single blade to be reused at least 12 times.

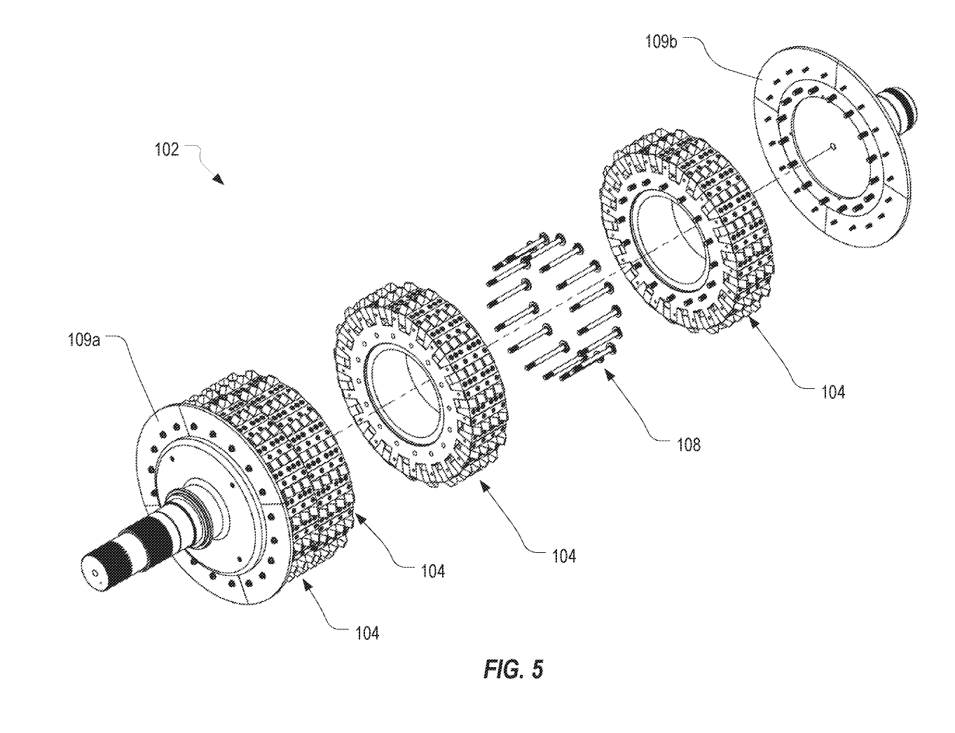

In some embodiments of the present invention, rotor assembly 102 can be modular as is represented in FIG. 5. As shown, rotor assembly 102 can include a first endplate 109a to which a first rotor 104 is secured. A second rotor 104 is also shown as being secured to the first rotor 104 while a third and fourth rotor 104 are shown separated from the other two rotors. Each of these rotors 104 can be configured to couple to another rotor 104 or to endplate 109a via bolts 108. Then, once the desired number of rotors 104 has been coupled together, a second endplate 109b can be secured to the outermost rotor 104. By coupling the rotors directly to one another between opposing endplates, rotor assembly 102 can have a hollow interior to facilitate cooling. However, other rotor designs could equally be used in conjunction with the other features of the present invention including designs in which the rotors are pressed onto or otherwise secured to an axle or shaft.

As shown in FIG. 5, each adjacent rotor 104 is offset slightly so that the blades 105 on one rotor are staggered with respect to an adjacent rotor. In one non-limiting configuration, the blades 105 are staggered in a slight spiral configuration. In this manner, only one blade 105 of a given rotor will interface with a given set of stationary knives at a specific time.

This modular design facilitates creating rotor assemblies of varying lengths. For example, to produce a shredder having a larger/longer shredding interface, additional rotors 104 could simply be added to the four rotors 104 shown in FIG. 5. The modular design also facilitates replacing an individual rotor without needing to replace the entire rotor assembly. For example, if one rotor 104 is damaged, the rotor assembly 102 can be disassembled to the point that the damaged rotor can be removed (e.g., by first removing any intervening rotors) and replaced while any undamaged rotors can continue to be used.

Endplates 109a and 109b can be configured with the necessary components (e.g., gears) to allow rotor assembly 102 to be rotated. Also, although not shown in FIG. 5, endplates 109a and 109b can be configured to allow a cooling fluid or air to be injected through each of rotors 104. For example, a cooling fluid may be pumped through first endplate 109a then through each of rotors 104 prior to exiting through endplate 109b. In this way, rotors 104 can be cooled during the shredding process.

Returning to FIG. 2A, in some embodiments, a demagnetizer may be employed in conjunction with stationary knife assembly 103. When shredding tires, the wires that are oftentimes included in the tires may become magnetized during the shredding process. These magnetized wires may then be attracted to the stationary knife assembly 103, particularly between the two stationary knives, and will therefore never reach screen 101c. As a result, it may be necessary to periodically remove the magnetized wires. This results in downtime and additional burden when operating a shredder. To address this issue, the present invention may incorporate a demagnetizer (not shown) as part of or adjacent to stationary knife assembly 103. This demagnetizer can remove the magnetization that may have built up in the wires and/or the stationary knife assembly thereby allowing the wires to pass through stationary knife 103b towards screen 101c.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. assembly. For example, if one rotor 104 is damaged, the rotor assembly 102 can be disassembled to the point that the damaged rotor can be removed (e.g., by first removing any intervening rotors) and replaced while any undamaged rotors can continue to be used. Endplates 109a and 109b can be configured with the necessary components (e.g., gears) to allow rotor assembly 102 to be rotated. Also, although not shown in FIG. 5, endplates 109a and 109b can be configured to allow a cooling fluid or air to be injected through each of rotors 104. For example, a cooling fluid may be pumped through first endplate 109a then through each of rotors 104 prior to exiting through endplate 109b. In this way, rotors 104 can be cooled during the shredding process.

Returning to FIG. 2A, in some embodiments, a demagnetizer may be employed in conjunction with stationary knife assembly 103. When shredding tires, the wires that are oftentimes included in the tires may become magnetized during the shredding process. These magnetized wires may then be attracted to the stationary knife assembly 103, particularly between the two stationary knives, and will therefore never reach screen 101c. As a result, it may be necessary to periodically remove the magnetized wires. This results in downtime and additional burden when operating a shredder. To address this issue, the present invention may incorporate a demagnetizer (not shown) as part of or adjacent to stationary knife assembly 103. This demagnetizer can remove the magnetization that may have built up in the wires and/or the stationary knife assembly thereby allowing the wires to pass through stationary knife 103b towards screen 101c.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A secondary shredder comprising:
a body having an internal compartment and an opening into the internal compartment;
a stationary knife assembly comprising one or more stationary knives positioned within the internal compartment; and
a rotor assembly positioned within the internal compartment, the rotor assembly having one or more rotors, each rotor having a plurality of blades which form a shredding interface with each of the one or more stationary knives;
wherein each blade is symmetrical around a horizontal axis and a vertical axis.

2. The secondary shredder of claim 1, wherein each rotor includes a number of radial extensions forming gaps in which the blades are secured to the rotor.

3. The secondary shredder of claim 2, wherein each radial extension includes one or more keyways and each blade also includes one or more keyways corresponding to the one or more keyways of the radial extension such that, when the blade is positioned adjacent to the radial extension, one or more keys may be inserted into the one or more keyways of the radial extension and into the one or more keyways of the blade to orient the blade relative to the radial extension.

4. The secondary shredder of claim 3, further comprising:
a number of wedges, each wedge being configured to insert into one of the gaps alongside a corresponding blade and to be secured to a corresponding rotor, and wherein, when the wedge is secured to the rotor, the wedge applies a force against the blade to secure the blade against the radial extension.

5. The secondary shredder of claim 4, wherein each wedge includes bolt holes, the wedge being secured to the rotor via bolts that insert through the bolt holes and into a surface of the rotor within the gap.

6. The secondary shredder of claim 3, wherein each blade includes one or more keyways on each side of the blade, each keyway being centered along a horizontal axis of symmetry.

7. The secondary shredder of claim 1, wherein the one or more rotors comprise a plurality of rotors, each rotor being independently removable from the rotor assembly.

8. The secondary shredder of claim 1, wherein each of the one or more rotors has an opening that passes through a middle of the rotor.

9. The secondary shredder of claim 8, wherein the rotor assembly is configured to pump a cooling fluid through the opening in each of the one or more rotors.

10. The secondary shredder of claim 1, wherein the stationary knife assembly comprises a first stationary knife positioned on a first side of the rotor assembly near or at the opening into the internal compartment and a second stationary knife that is also positioned on the first side of the rotor assembly.

11. The secondary shredder of claim 10, wherein the second stationary knife is positioned above a longitudinal axis of the rotor assembly.

12. The secondary shredder of claim 1, further comprising:
a demagnetizer incorporated into or positioned adjacent to the stationary knife assembly.

13. A secondary shredder comprising:
a body having an internal compartment and an opening into the internal compartment;
a stationary knife assembly comprising a first set of stationary knives and a second set of stationary knives that extend along a width of the internal compartment and protrude into the internal compartment; and
a rotor assembly comprising a plurality of rotors, each rotor comprising a number of radial extensions that are spaced around a circumference of the rotor thereby forming a number of gaps, and wherein each gap includes a blade and a wedge that secures the blade to an adjacent radial extension, the rotor assembly being positioned within the internal compartment such that the blades form a shredding interface with the first and second sets of stationary knives.

14. The secondary shredder of claim 13, wherein the adjacent radial extension includes keyways on an inner surface and the blade includes corresponding keyways on both sides of the blade.
